(19) United States
(12) Patent Application Publication
(10) Pub. No.: US 2012/0217182 A1
(43) Pub. Date: Aug. 30, 2012

(54) TABLET MANUFACTURE

(75) Inventors: Poon Liebenberg, Woodmead (ZA); Thomas Wiid, Woodmead (ZA)

(73) Assignee: WAXTABS (PTY) LTD, Woodmead (ZA)

(21) Appl. No.: 13/390,602

(22) PCT Filed: Aug. 16, 2010
(86) PCT No.: PCT/ZA2010/000045

§ 371 Date: May 1, 2012

(30) Foreign Application Priority Data
Aug. 17, 2009 (ZA) 2009/05684
Dec. 8, 2009 (ZA) 2009/08736
Apr. 20, 2010 (ZA) 2010/02780

(51) Int. Cl. B29C 39/24; B65D 85/00

(52) U.S. Cl. 206/526; 264/299

(57) ABSTRACT

A method of making a tablet wherein a measured volume of a settable fluent wax or polymer matrix is placed in an upwardly facing mould cavity under controlled conditions to ensure that an upper surface of a resulting bead, in the cavity, has a shape and size which are substantially the same as the shape and size of a lower surface of the bead is determined by the mould cavity.

### BACKGROUND OF THE INVENTION

This invention relates a process for manufacturing a tablet using a fluent, settable matrix

The use of waxes or polymers as matrix components in pharmaceutical compositions holds potential advantages which include the following: formation of solid solutions or solid suspensions; improved absorption and efficacy of poorly water-soluble substances; improved bioavailability; reduced dosing frequency; no solvents; GRAS (generally regarded as safe) status of matrix components, and thus suited for natural health products; single, continuous process manufacture; environmentally friendly; improved content uniformity due to intense mixing; components of polymer/wax matrix may act as thermal binders, drug stabilizers or solubilizers; lower risk of dose dumping; lower temperatures than hot melt extrusion; improved stability; reduced dosing frequency; multi-release possibility; and tailored release profiles.

The judicious selection of matrix components allows for the manipulation of the release rate of an active component from the matrix, and the creation of tailored release profiles. This can result in reduced dosing frequency, and improved patient compliance, as well as fast onset or sustained release systems. The correct choice of matrix components (from amongst others: binders, solubilizers, stabilizers, polymers, waxes and surfactants) may also allow improved bioavailability of an active formulated in the matrix, as well as improved stability of the end product. The absorption and efficacy of poorly water-soluble compounds may be increased.

The manufacture of a tablet using wax, polymer or a similar settable material can be problematic. For example if an injection moulding process is used then the effects of viscosity and surface tension of a molten wax mixture present technical difficulties. Another technique, referred to as a hot melt extrusion process, is carried out at relatively high temperatures, with the risk of API (Active Pharmaceutical Ingredient) degradation, and often requires subsequent granulation and compression of the extrudate into final tablets.

Other technologies for the manufacture of wax-based dosage forms require a process of granulation (with solvent) and subsequent compression of a granulate into tablets. Variations in granule size may cause challenges in the pressing of tablets and binders are required for tablet formation. Also, API particle distribution may not exhibit a desirable level of uniformity.

One of the challenges of each of these technologies, to the applicant's knowledge, lies in the provision, in a relatively easy manner, of a single tablet which has multiple release capabilities.

The present invention is concerned with a method of making a tablet from a fluent settable matrix which at least in a preferred embodiment, allows many of the aforementioned benefits to be achieved.

### SUMMARY OF INVENTION

The invention provides a method of making a tablet which includes the steps of providing a mould cavity which faces upwardly and which has a lower section with a defined shape and size, preparing a settable fluent matrix, placing a predetermined quantity of the fluent matrix in or on the mould cavity, controlling at least one variable parameter to cause an upper surface of the fluent matrix to assume substantially the defined shape and size of the lower section, and allowing the fluent matrix to solidify into a body which has an upper portion which has substantially the defined shape and size determined by the control of the at least one variable parameter.

The matrix may be temperature settable i.e. it sets (solidifies) when its temperature drops below a defined level.

Preferably the at least one variable parameter is selected at least from the following:

a) the composition of the matrix;
b), the temperature of the matrix;
c) the viscosity of the matrix; and
d) the rate at which the temperature of the matrix is lowered.

The magnitude of the predetermined quantity i.e. the volume of the fluent matrix has a material bearing on the shape and size of the upper surface of the body and is therefore precisely controlled and is adjusted as is necessary if the composition of the matrix is altered in a way which affects the setting thereof.

It is possible to form the mould cavity so that letters, logos and the like are formed in at least an outer surface of the lower portion of the solidified body. Markings of this type, which generally are of a marketing or identifying nature, are not regarded as forming part of the defined shape and size of the lower section of the mould cavity.

In one form of the invention the mould cavity is directly contacted by the fluent matrix and, upon solidification of the matrix, the lower section of the mould cavity causes a lower portion of the body to have the defined shape and size.

In a different form of the invention the predetermined quantity of the fluent matrix is placed over or adjacent at least one fluent composition previously placed in or on the lower section of the mould cavity and which has then been allowed to set. A lower portion of the at least one composition then has the defined shape and size as determined by the shape and size of the lower section.

In one preferred embodiment of the invention the mould cavity has the lower section which has the defined shape and size and an upper section which has a side wall.

In one form of the invention the side wall, during implementation of the method, is generally vertical.

The side wall is shaped to ensure that the tablet will readily be released, e.g. ejected, from the mould cavity once the matrix has set. This release must be accomplished without adversely affecting the desired tablet shape.

A surface of the side wall at a mouth of the mould cavity may subtend an angle, to a surface surrounding the mould cavity, of from 90° to 110°. At least part of the side wall, viewed from one side, may be concave or in the shape of a shallow V or, more generally, may be slightly undercut. The side wall shape is determined, at least, by the requirement that the tablet must be readily releasable from the mould cavity; a characteristic which, in turn, is dependent at least on the nature of the material (e.g. its resilience and elasticity) which defines the mould cavity.

By careful control of the at least one variable parameter the upper portion of the body is caused to take on the defined shape and size. The lower portion of the body has the defined shape and size, as determined by the lower section of the mould cavity. A portion of the body, between the upper and lower portions, has a size and shape determined by the side wall of the mould cavity.

Without being bound by the following explanation the applicant has proceeded on the basis that if the temperature of the fluent matrix when placed in or on the mould cavity is sufficiently high, then its viscosity is reduced and surface tension effects exhibited in the fluent matrix are substantially reduced. Conversely as the temperature is decreased surface tension effects become more pronounced and the convexity or roundness of the upper surface of the fluent matrix increases. This process can also help to contain the fluent matrix so that it does not spill over from the mould cavity. The control step is then used to regulate the temperature and viscosity of the matrix (characteristics which are dependent, at least, on the composition of the matrix) to achieve, in a repeatable manner, the defined shape and size of the upper portion of the tablet. Primarily this is done to ensure that the tablet has a symmetrical shape i.e. with the upper portion substantially the same as the lower portion.

Features such as the speed at which the fluent mixture is placed into the mould cavity, and the speed of movement of the mould cavity, while the matrix is setting, are readily determined by experimentation and observation, in practice, for each particular composition.

The temperatures at which the sought-after shapes are achieved can be determined, with relative ease, through experimentation. These temperatures depend, at least, on the composition of the fluent matrix. It is then possible to shape at least the lower section of the mould cavity accordingly. Consequently during tablet manufacture if the temperatures and other variables are reproduced the upper portion of the tablet has essentially the same shape and size (as determined by parameter control) as the lower portion (as determined by the shape and size of the lower section of the mould cavity). If a small change takes place in the composition of the matrix then a mould cavity of a given size and shape can still, in most instances, be used successfully by making small adjustments to the relevant parameters.

In order to achieve one or more of the aforementioned potential advantages and to produce a fluent matrix which is susceptible to parameter control so that the upper surface of the fluent matrix takes on a predetermined shape and size, use may be made of at least one of the following settable substances: suitable waxes such as beeswax, candellila wax, carnauba wax, rice bran wax, paraffin wax, and micro-crystalline wax, and suitable polymers, gums and gels.

Any appropriate active ingredient or ingredients may be included in the fluent matrix which thus acts as a carrier. The active ingredient may be one or more of the following: a pharmaceutical active or drug, a vitamin, a mineral and, in general, any selected product or ingredient.

The matrix may optionally include a release modifying or release controlling agent which may be selected from at least the following: polyvinyl pyrrolidone; polyethylene glycol; hydroxypropyl methylcellulose or any alternative vegetable cellulose derivative; and Gelucire (trade mark—manufactured by Clariant). The active ingredient included in the matrix may, itself, act as a release modifying agent.

Additional ingredients to be included in the matrix to enhance its properties may be selected from at least the following: emulsifiers, solubilizers, stabilizers, thickeners and surfactants such as sucrose monopalmitate.

The shape of the upper portion of the matrix, as setting (cooling) takes place, can be influenced by a number of other factors. The rate of cooling of the matrix can for example produce distortion. If the cooling rate is too high distortion may occur. To address this it falls within the scope of the invention to use a mechanism which regulates the cooling rate in order to minimize distortion. Similarly, the composition of the matrix usually has an effect on the shape of the upper surface of the solidified matrix. Carnauba wax, for example, deforms substantially upon cooling whereas beeswax is not as prone to distortion. A mixture of these components can be used to produce a product which is not particularly susceptible to distortion and which has an acceptable end shape and surface qualities i.e. not sticky.

The mould cavity may be one cavity of a plurality of cavities formed in a substrate which is made from a flexible material of suitable characteristics e.g. rubber or a similar synthetic material. In this form of the invention the body, once solidified, may be ejected or otherwise removed from the mould cavity for subsequent packaging, bottling or the like. It is important in this respect to ensure that the mould cavity has a shape which does not impede removal of a tablet from the cavity. In this regard it is also necessary to take into account the nature of the material used to define the mould cavity e.g. the flexibility of the material.

In an alternative form of the invention the body, upon solidification, is left in the mould cavity which is formed in a first packaging element. Thereafter a second packaging element is superimposed on the first packaging element, to extend over the solidified body, and the packaging elements are secured together to form an enclosure for the solidified body. This process may be effected substantially simultaneously for a number of mould cavities and continuously along the lengths of the packaging elements. Any appropriate packaging elements may be used, e.g. blister pack components.

The last mentioned form of the invention thus eliminates a manufacturing step and the need for a reusable, separately formed mould. This reduces costs and increases efficiency.

A composition which has been formulated and manufactured in the described way results in high content uniformity, i.e. an even and fine distribution of the active ingredient or ingredients in the final product, effectively a solid solution or a solid-suspension or -dispersion. The choice of matrix components from a range of ingredients with GRAS status (particularly waxes, such as beeswax), allows for the use of this technology in the manufacture of products for the natural health products (or nutriceutical) market, and may also reduce regulatory challenges in the pharmaceutical environment. Wax- or polymer-based tablets can be manufactured as floating tablets, and can also reduce the risk of dose dumping.

The manufacture of wax- or polymer-based matrix tablets as contemplated herein requires no solvents, is environmentally friendly, and can be performed in a single continuous process.

### BRIEF DESCRIPTION OF THE DRAWINGS

The invention is further described by way of examples with reference to the accompanying drawings in which:

FIG. 1 is a block diagram representation of apparatus for use in a method of making a tablet according to the invention;

FIG. 2 is a side view in section of a tablet in a mould cavity immediately after formation of the tablet;

FIG. 3 illustrates how the tablet in FIG. 2 can be recovered from the mould cavity;

FIGS. 4 to 8 illustrates successive steps in the manufacture of tablets according to a variation of the invention;

FIGS. 5A and 8A are side views of the arrangements shown in FIGS. 5 and 8 respectively;

FIGS. 9 to 13 respectively depict modified methods according to the invention; and

FIGS. 14 and 15 illustrate different possible mould cavity shapes.

### DESCRIPTION OF PREFERRED EMBODIMENT

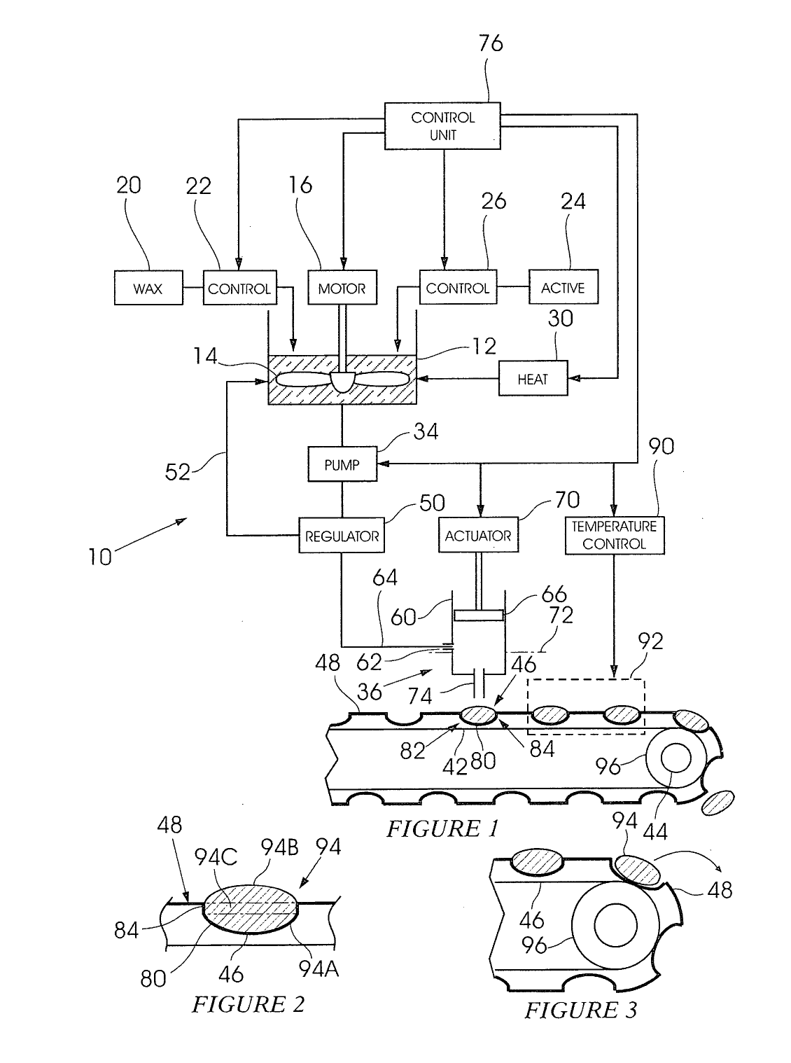

FIG. 1 of the accompanying drawings diagrammatically illustrates one form of apparatus 10 for preparing a fluent settable matrix for use in the method of the invention.

The apparatus includes a mixing container 12 with a mixer blade 14 or a similar device which is driven by a controllable motor 16. A measured quantity of a settable material 20, which is used as a carrier, is placed into the container 12 by means of a control device 22 such as a valve. A metered quantity of an active ingredient or ingredients 24 is placed into the container through a control device 26. Heat from a source 30, which may use electrical elements or gas, is used to raise the temperature of the container 12 and its contents in a controlled way.

A positive displacement pump 34 is used to convey fluent material from the container to a dispenser 36 which is one of a plurality of similar devices, not shown, positioned above a conveyor belt 42 which is movable in a regulated manner by means of a suitable drive motor 44. A mould cavity 46, which is one of a number of similar cavities, is formed in an upper surface 48 of the conveyor belt and is locatable directly below the dispenser 36.

The belt 42 is made from a flexible material with suitable characteristics such as rubber or a similar synthetic material.

The pump 34 operates through a regulator 50 which controls the pressure in the dispenser 36. Excess material delivered to the regulator is returned to the container through a line 52.

The dispenser 36 includes a cylinder 60 with an entry port 62 which is connected to a line 64 leading from the regulator 50. A piston 66 is reciprocally mounted in the cylinder and is movable by means of an external actuator 70, the operation of which is linked to the speed of movement of the conveyor belt. The cylinder is rotatable about a horizontal axis 72. At one end the cylinder has a nozzle 74. The operation of the dispenser is such that, when the nozzle faces upwardly, material from the container is pumped into the cylinder via the port 62. This is with the piston withdrawn. Thereafter, when the nozzle faces downwardly, the piston is operated to expel the content of the cylinder through the nozzle into the upwardly facing mould cavity 46. Indexing techniques are used to ensure that discharge from the nozzle is accurately controlled relative to the speed of movement of the conveyor belt and the position of the mould cavity.

The various components are connected to a computer-based unit 76 which controls, at least, the mixing process, the heating of the container, the working of the pump, the movement of the conveyor, and the operation of the actuator and of the dispenser.

The fluent matrix may be prepared using any suitable apparatus and the aforegoing description is exemplary only and non-limiting.

The mould cavity, viewed from one side, has a lower section 80 with a dished or concave profile, and an upper section 82 with a side wall 84 which, in use, is generally vertical and at a right angle to the upper surface 48 of the conveyor belt. The shape of the lower section is largely determined by measuring the shapes of upper body portions of different formulations and different volumes, of temperature settable, fluent matrixes (of the kind described hereinafter) which are allowed to solidify under various sets of controlled conditions.

The shape of the mould cavity as depicted in FIG. 2 is exemplary only. Other shapes are possible and, in this respect, regard should be had, for example, to the comments herein which relate to FIGS. 14 and 15.

In use of the apparatus wax 20 of a suitable grade is placed in a precisely measured quantity via the control device 22 into the container 12. The temperature of the container is increased by the heating source 30 to melt the wax. From empirical data and operating parameters determined previously the temperature of the fluent matrix is precisely controlled taking into account at least the nature of the composition of the matrix. Thereafter a measured quantity of active ingredients 24, selected for example from vitamins, trace elements and pharmaceutical compositions, is added to the molten wax via the control device 26. Release control and modifying agents and stabilizers, emulsifiers, thickeners, surfactants and stabilizers are also included according to requirement. The mixer 14 is activated to ensure that all the materials inside the container are thoroughly mixed to produce a composition which includes the same constituents, in the same amounts, and which is at the same temperature, as a selected formulation which was employed when the shape and size of the lower section of the mould cavity were determined. Small adjustments to these variables can however be made, as required, to take account of any effects resulting from a minor variation in the makeup of the composition.

Once the molten matrix has been prepared the pump 34 is operated to pump the matrix to the dispenser. When the discharge nozzle 74 is directly positioned above the mould cavity 46 the actuator 70 is operated. The volume of the fluent matrix which is dispensed and other operating parameters are carefully controlled to ensure that a precisely metered volume of the matrix is placed in the mould cavity. The excess material forms an upwardly extending bead which projects above the surface 48 of the conveyor belt around the mould cavity and which defines an upper portion of a tablet which is being formed. By carefully controlling and repeating the various parameters which were initially used to determine the shape and size of the lower section of the mould cavity, the upper portion of the tablet is caused to take on substantially the same shape and size as the lower portion of the tablet.

The rate of cooling of the fluent matrix in the mould cavity can be controlled in any appropriate way, e.g. by the application of hot or cold air which is directed from a source 90 onto a zone 92 through which the belt is passed.

FIG. 2 is a side view of a tablet 94 formed in the aforementioned manner. A lower portion 94A of the tablet conforms in shape and size to the shape and size of the lower section of the mould cavity. An upper portion 94B of the tablet conforms substantially in shape and size to the lower portion 94A. As indicated, this is achieved by carefully controlling, at least, the composition of the matrix, its temperature and its rate of cooling in accordance with data derived from earlier experiments so that the parameters which were used to determine the size and shape of the lower section of the mould cavity are accurately repeated. An intermediate portion 94C is shaped by the side wall.

The tablet 94, when it reaches a discharge end of the conveyor belt, can be ejected by causing the belt to pass over a forward roller 96, of relatively small diameter, as shown in FIG. 3. The belt 48 is flexible and the tight curvature of the roller causes the mould cavity to open. The tablet 94 is then loosened and readily ejected from the mould cavity. In a different technique the belt is passed over a roller which includes projections which are brought into register with the undersides of respective mould cavities. In each case a force is directly applied to the mould cavity which causes the tablet, in the cavity, to be ejected from the cavity.

Each tablet could be coated with any required material using a suitable technique known in the art. It is possible to form a tablet from two or more mixtures, each deposited in fluent form, one over the other, into a mould cavity, from different dispensers. In a variation of the invention solid, separately formed components of any appropriate composition are placed into a mould cavity, optionally on top of fluent material already in the cavity, and are then covered with fluent material, generally in the manner described, which is allowed to set.

In the preceding description the tablet 94 is formed in a reusable mould cavity and, upon ejection from the mould cavity, the tablet is collected for packaging purposes. In another form of the invention appropriate mould cavities are directly formed in packaging elements in order to obviate the tablet ejection process and to simplify packaging of the tablets.

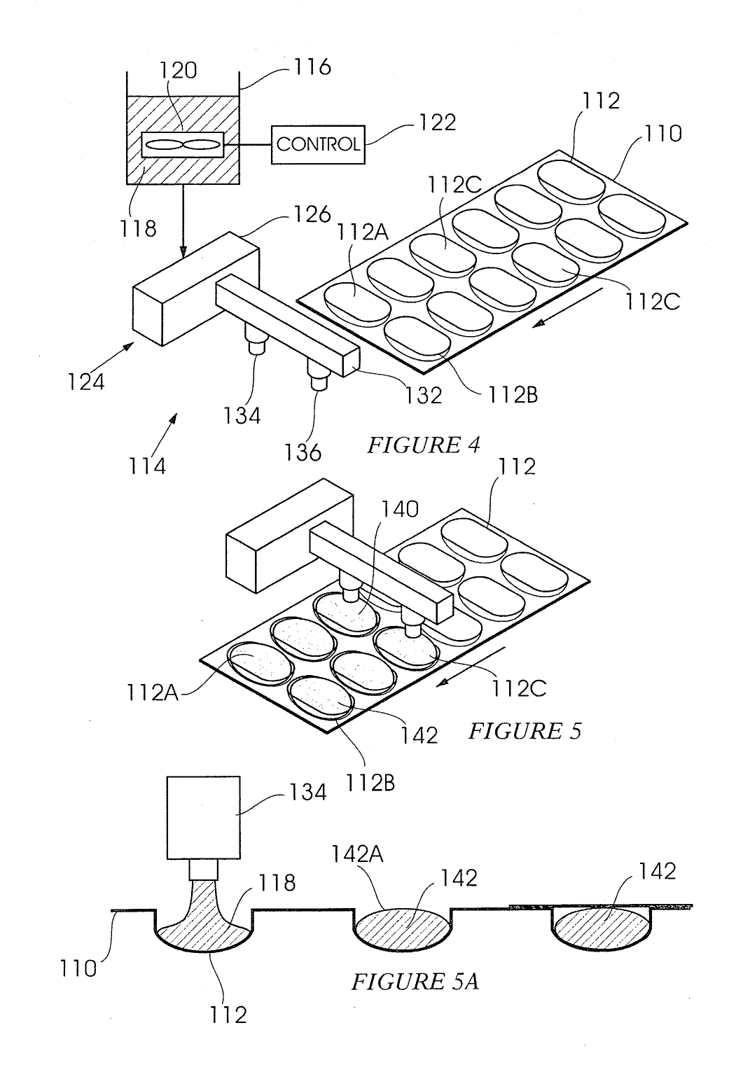

FIG. 4 illustrates, in perspective, a first packaging element 110 which is formed, at regular intervals, with a plurality of depressions 112. In this instance each depression has a lower concave section which is bounded on an upper end by a small substantially vertical side wall. In plan each depression has an oval shape at an upper surface of the packaging element. The shape of each depression, which acts as a mould cavity, is determined generally in accordance with the procedures which have been described hereinbefore.

The element 110 is made from any appropriate material and typically is a suitable plastic material, a foil, or the like. The invention is not limited in this respect.

FIG. 4 also illustrates a work station 114 which includes a vessel 116, with a stirring device, which contains a fluent tablet matrix 118. The matrix can be formed in any appropriate way and, by way of example only, is formed from a preparation of beeswax and one or more suitable ingredients such as vitamins, pharmaceutical compounds, release-controlling agents or the like as referred to hereinbefore. The mixture 118 is heated in a controlled way using an appropriate element 120 which operates under the control of a controller 122. Adjacent the vessel is a discharge mechanism 124 which includes a housing 126 which is connected via a line 130 to the vessel. An arm 132 extends from the housing and (in this example) two discharge nozzles 134 and 136 respectively are positioned on an underside of the arm.

The installation at the workstation 114 is similar to that shown in FIG. 1.

The packaging element 110 is fixed to, or carried by, an appropriate transport mechanism, not shown, such as a conveyor belt. The movement of the transport mechanism is accurately controlled in an indexed manner to bring successive pairs of the depressions 112A, 112B, etc. into register with the nozzles 134 and 136, with the depressions directly underlying the nozzles. The belt is then held stationary for a brief period and, thereafter, the next indexed step of movement takes place.

With the belt stationary a respective metered volume of the fluent tablet matrix 140, from the vessel 116, is discharged through each of the nozzles 134 and 136 into the underlying depressions which act as mould cavities for the mixtures. Each metered volume of tablet matrix cools and then sets as a bead 142 which has a lower portion and an intermediate portion which fill the mould cavity, and an upper portion, which stands proud of the material around the mould cavity, and which is substantially the same in shape and size as the lower portion.

The packaging element may have a defined length and width. Alternatively, the packaging element is provided in elongate form so that the beads 142 are formed on an ongoing basis in a continuous process. Subsequently the packaging element is severed into a plurality of discrete sections, each of a defined size. Preferably this step takes place after the stage shown in FIG. 7.

FIG. 5 shows leading pairs of depressions 112A and 112B already filled with respective metered quantities of the tablet mixture, and the fluent tablet mixture being discharged into a third pair of depressions 112C. FIG. 5A is a side view of the stage shown in FIG. 5. By controlling, inter alia, the temperature of the tablet mixture in the vessel, in the pipeline system and at the discharge mechanism, the shape of an upper portion of each bead 142, and hence of the resulting tablet, when the matrix sets, is determined. The mixture 118 is fluent but its temperature is not so high that the viscosity of the tablet mixture is much reduced. Under these conditions it has been found when the matrix solidifies that surface tension effects are such as to produce an upper surface 142A of the resulting bead which is convex and neatly rounded.

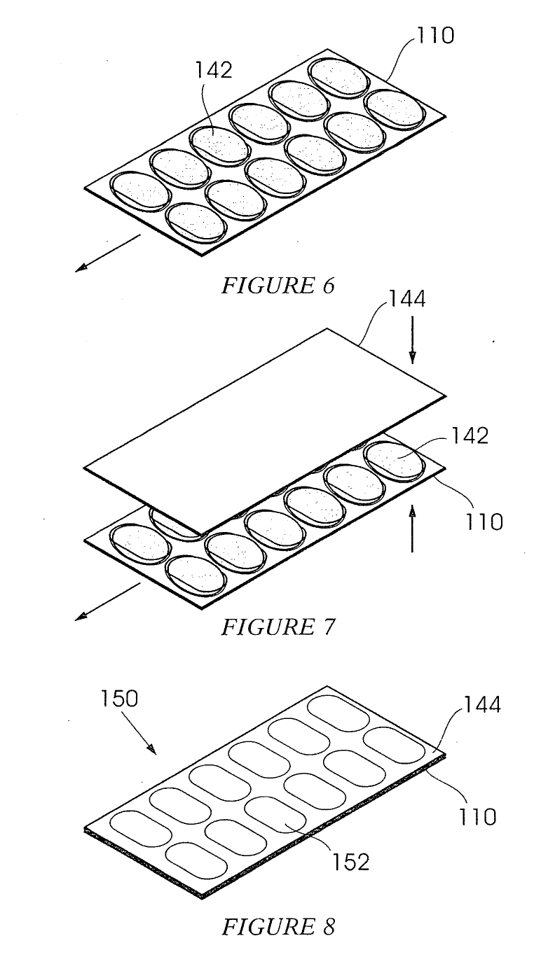

FIG. 6 illustrates the packaging element 110 moving downstream of the work station 114. Each of the depressions is filled with a corresponding solid bead 142 of the tablet mixture.

In the stage shown in FIG. 7 a second packaging element 144 is positioned above the first packaging element 110 using suitable material handling equipment. The two elements are then brought together and are secured to each other using an adhesive or by means of an appropriate heating or welding technique or the like thereby to form, for each tablet, a respective enclosure.

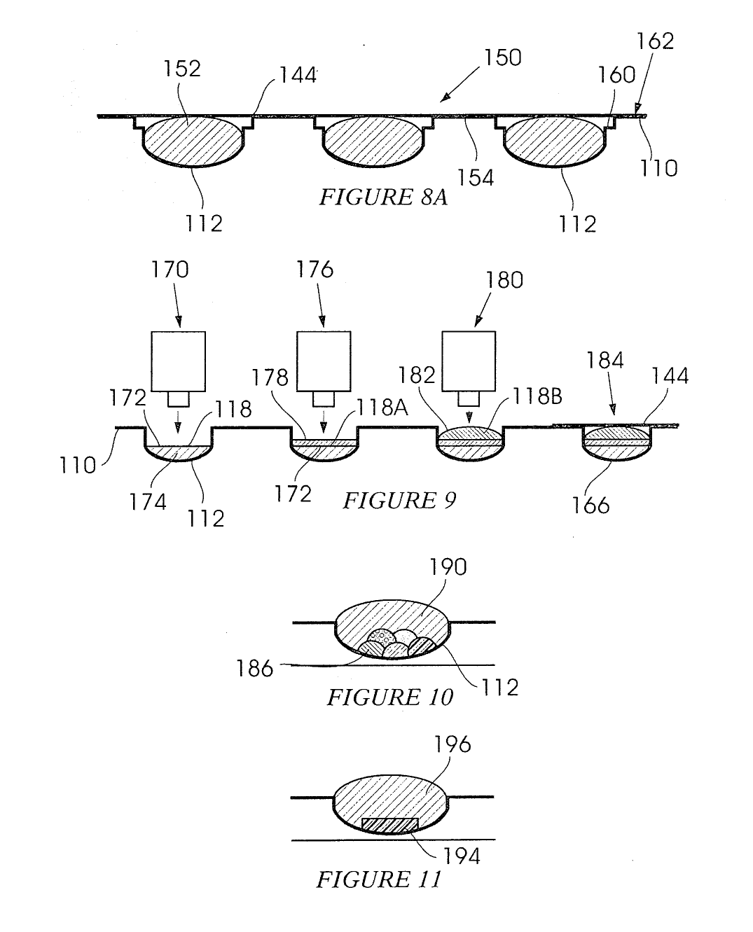

FIG. 8 depicts a resulting end product 150 which contains a plurality of the beads, each of which is now referred to as a tablet 152, held in a respective depression. The tablets are positioned between the opposing packaging elements in a secure and hygienic manner.

FIG. 8A is a side view of the packaged tablets and shows that the second packaging element 144 is adhered to the underlying first packaging element 110, particularly at locations 154 between adjacent pairs of depressions 112. Each tablet 152 is firmly held in position by opposing portions of the packaging elements.

Thus, the first packaging element 110 provides mould cavities which help to form the beads 142. The beads are not shaped in a separate mould but, instead, are formed in situ in the relevant packaging material and are retained therein for subsequent dispatch.

The shape of a bead (tablet), as cooling takes place, can be affected by a number of other factors. Reference has been made to the effect of temperature and, depending on the nature of the matrix, the effect can be more or less pronounced. For example the rate of cooling of the bead can influence distortion. If the cooling rate is too high distortion may well occur. To address this possibility it falls within the scope of the invention, as has been referred to in connection with FIG. 1, to use a mechanism which regulates the cooling rate in order to minimize distortion. A further factor is the composition of the matrix. For example carnauba wax deforms substantially upon cooling. Beeswax on the other hand is not as prone to distortion. A mixture of these components can therefore be used to produce a product which does not distort easily and which has an acceptable end shape and surface qualities e.g. not sticky.

The tablet matrix can be made from an appropriate mixture of ingredients selected for example from waxes such as beeswax, carnauba wax, and microcrystalline wax, polymers, release-controlling or-modifying agents, surfactants, stabilizers, solubilizers and so on. The invention is not limited in this regard.

The invention can be implemented in a variety of ways and the preceding descriptions are by way of examples only. For example the packaging element can be carried by a conveyor belt or other transport mechanism. In a variation of the invention the packaging element itself is driven by a suitable drive arrangement and is moved over underlying structure. This approach eliminates the need for a separate conveyor belt. A lubricant can be used, if required, on the packaging element to facilitate its smooth passage past the workstation. If necessary use can be made of a release agent which is applied to relevant surfaces, at least of the packaging element 110, to facilitate the easy release, when required, of a tablet which, possibly, is sticky or which otherwise has a tendency to adhere to the surface of the packaging element in which it is formed.

To enable a user to grip a tablet it is advantageous if each depression 112 is formed with a surrounding ledge 160 which is recessed relative to an upper surface 162 of the surrounding material of the first packaging element. The recessed surface can also assist with optimal formation of the tablet, and provides clearance between the tablet and the second packaging element.

FIG. 9 illustrates how a tablet 166, of compound nature, can be made. In a first step 170 a fluent tablet matrix 118 is discharged into a mould cavity constituted by a depression 112 in a first carrier element 110. The matrix has a high temperature and, when it sets, an upper surface 172 of a bead 174 which is thereby formed is relatively flat. In a subsequent step 176 a relatively small metered volume of a second tablet matrix 118A is discharged directly onto the surface 172. Again the temperature is relatively high so that the second tablet mixture sets with a substantially flat upper surface 178. In a third step 180 a third tablet matrix 118B is discharged onto the surface 178. In this instance the temperature of the matrix 1186 is relatively low and cooling of the matrix 1186 is controlled so that surface tension effects are pronounced. Thus, as the matrix sets it forms a convex upper surface 182. In a final step 184 a packaging element 144 is superimposed over the element 110 and is secured thereto in the manner which has been described.

At relatively high temperatures a bonding effect between adjacent layers of the matrix is enhanced. If a lower layer has cooled prior to the application of a hotter, upper layer then an indentation may occur at a surface of the boundary between the layers. This type of unwanted effect can be addressed by manipulating temperatures or the compositions of the matrix.

Some ingredients which may be fat-or water-soluble are inclined to dissolve, substantially completely and evenly, in a wax carrier. The reason why these ingredients dissolve, or go into suspension, is not known to the applicant. Certain ingredients melt at known temperatures and this feature allows these ingredients to be easily mixed with the waxes. Some ingredients go into suspension easily. Other ingredients need to be stirred vigorously to go into suspension. There may be additives that can induce ingredients to go into suspension more readily. These characteristics can be used to facilitate preparation of the matrix.

The technique described in connection with FIG. 9 allows for the manufacture of a compound tablet. For example, each portion of the tablet matrix can carry a respective ingredient or ingredients. The relative proportions of the ingredients can be varied, within reason, according to requirement. Another possibility is to have different formulations which allow for different reaction rates of the ingredients e.g. for fast take-up or slow release.

FIG. 10 illustrates another technique for making a compound tablet. A first packaging element is formed with a depression 112. Preformed beads 186, each with desired characteristics, are placed in the depression and an appropriate binder 190 such as beeswax or a polymer is placed over the beads, in the manner described, thereby to form a compound tablet.

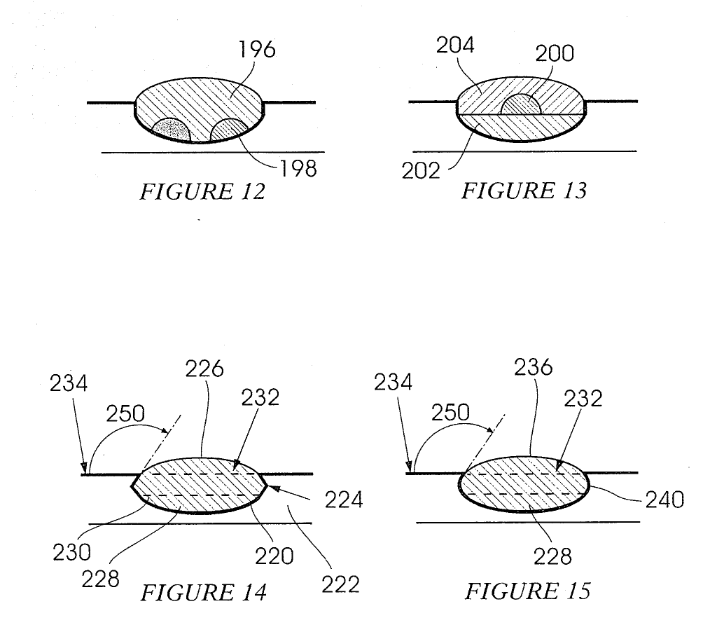

In FIG. 11 a single preformed tablet 194, produced for example by a pressing technique, is placed in the mould cavity and is then covered with a binder/matrix 196. FIG. 12 shows a construction which is based on the use of two small preformed beads 198. FIG. 13 illustrates a layered construction wherein a preformed bead 200 is placed on a solidified lower layer 202 in a lower section of a mould cavity. An upper tablet portion 204 , covers the bead and the lower portion.

In FIG. 2 the mould cavity has a side wall 84 which is more or less at a right angle to a surrounding upper surface of the conveyor belt in which the cavity is formed. This type of mould cavity should be used when a tablet is formed in a packaging element for it allows the tablet to be removed, with ease, from the element. However if the mould cavity is formed in a flexible resiliently deformable conveyor belt (this is the case for example when the mould cavity is re-used) then other shapes are possible.

FIG. 14 shows a mould cavity 220 which is formed in a conveyor belt 222 which is made from a flexible deformable material such as silicone rubber. Opposed ends of a side wall 224 of the cavity have a shallow V-shape (viewed from one side). A tablet 226 formed in the mould cavity has a lower portion 228, demarcated by a dotted line 230 with a shape and size which are substantially identical to the shape and size of an upper portion 232 of the tablet which stands proud of an upper surface 234 of the belt.

FIG. 15 shows a tablet 236 in which a similar situation prevails and wherein like elements are designated with like reference numerals to those employed in FIG. 14. However the side wall 240 has a gentle concave shape at each of its opposed ends (in a longitudinal sense which coincides with the direction of belt travel).

In each case when the belt passes over a small roller, as described in connection with FIG. 3, the cavity can open sufficiently to allow the tablet to be ejected. Depending on the nature of the material used in the conveyor belt a surface of the side wall, at a mouth of the cavity, can subtend an angle 250 of up to 110° to an adjacent upper surface of the belt and the cavity can be deformed sufficiently to cause easy ejection of the tablet when required. This approach still allows for the tablet to be substantially symmetrical, with a pleasing shape, with substantially identical upper and lower portions which are separated by an intermediate portion which is defined by the side wall of the mould cavity.

As the angle 250 is reduced to below 90° there is an increasing tendency for surface tension effects to be diminished and, when this occurs, the fluent mixture can spill over onto the surrounding surface of the belt and produce a tablet which has an incorrect shape.

Other forms of the invention can be devised which, although making use of the inventive principles contained herein, could result in a tablet which has a different construction from what is described or illustrated herein. Without being exhaustive the following types of construction are included in the scope of the invention:

a) a tablet which has two or more overlying layers of the same or different constituents,

b) a tablet in which one or more small pellets or beads which, optionally, are preformed, are embedded wholly or partially in one or more fluent layers which are allowed to set,

c) a tablet wherein a first layer of a settable medium carries one or more preformed pellets or beads which are covered by a second layer of a fluent medium, allowed to set in situ, which bonds to the first layer,

d) a tablet wherein two or more pellets or beads, optionally preformed, with the same or different active ingredients, are held together by a binder e.g. of polymer, a wax or a combination thereof which, optionally, carries one or more active ingredients, and

e) a bead or pellet which carries one or more active ingredients and which is at least partly embedded in one or more layers of a fluent matrix which is allowed to set. For example a capsule which contains an appropriate gel or a freeze-dried or a quick release bead could be encapsulated in the fluent matrix.

The degree of convexity of the upper surface of the fluent matrix can be controlled to a greater or lesser extent of varying one or more of the following: the shape of the mould cavity; the volume of the fluent matrix which is placed in the mould cavity; surface tension effects which depend on viscosity and temperature; and the composition of the matrix which could be a suitable blend of wax, polymer and a release-controlling agent.

The effects of temperature on shaping the upper surface of the tablet are variable. At a high temperature the matrix expands to a greater extent than at a lower temperature. If the matrix is heated to a very high temperature, it shrinks significantly on cooling, causing deformation (indenting) of the upper surface of the tablet. At a lower temperature, the effects of shrinkage are less pronounced, thus enabling the rounded shape of the upper surface of the tablet to be maintained.

The technique which is used to prepare the fluent tablet matrix can have an effect on the ingredients. For example, exposure to an elevated temperature over a prolonged period could be adverse to the ingredients, and it may be desirable to reduce the heat-exposure time to a minimum for a heat-sensitive product and, instead of using a melting vessel, a device such as a heated screw pump or an extruder could be used to produce a fluent matrix in a relative short period of time.

1-12. (canceled)

13. A method of making a tablet which includes the steps of providing a mould cavity which faces upwardly and which has a lower section with a concave shape and a defined size, preparing a settable fluent matrix, placing a predetermined volume of the fluent matrix in or on the mould cavity whereby a lower surface of the matrix has a convex shape determined by said concave shape of the lower section of the mould cavity, controlling at least one variable parameter to cause an upper surface of the fluent matrix to assume a convex shape which is substantially the same as the convex shape of the lower portion of the matrix, and allowing the fluent matrix to solidify into a body which has an upper portion which has said convex shape of the upper surface, and a lower portion which has said convex shape of the lower surface.

14. A method according to claim 13 wherein the at least one variable parameter is selected from the following:
a) the composition of the matrix;
b) the temperature of the matrix;
c) the viscosity of the matrix;
d) the rate at which the temperature of the matrix is lowered; and
e) the volume of the predetermined quantity.

15. A method according to claim 14 wherein said predetermined volume of the fluent matrix is greater than said defined size of the mould cavity.

16. A method according to claim 13 wherein said predetermined volume of the fluent matrix is greater than said defined size of the mould cavity.

17. A method according to claim 13 wherein the predetermined volume of the fluent matrix is placed over or adjacent at least one composition previously placed in or on the mould cavity.

18. A method according to claim 13 wherein the mould cavity has the lower section which has said concave shape and said defined size and an upper section which has a side wall which is shaped to allow the body to be released from the lower section.

19. A method according to claim 18 wherein the side wall, during implementation of the method, is generally vertical.

20. A method according to claim 18 wherein the mould cavity is formed in a resiliently deformable material and a surface of the side wall subtends an angle of from 90° to 110° to a surface surrounding the mould cavity.

21. A method according to claim 13 wherein the matrix includes at least one active ingredient and at least one of the following: a wax and a polymer.

22. A method according to claim 21 wherein the matrix includes at least one of the following: a release modifying or release controlling agent; an emulsifier; a surfactant; a thickener; a stabilizer and a solubilizer.

23. A method according to claim 13 which includes the step of ejecting the solidified body from the mould cavity.

24. A method according to claim 13 which includes the steps of providing the mould cavity in a first packaging element, leaving the solidified body in or on the mould cavity, superimposing a second packaging element on the first packaging element so that it extends over the solidified body, and securing the first packaging element to the second packaging element thereby to form an enclosure for the solidified body.

25. A packaged product which includes a first packaging element which has a plurality of depressions, a plurality of tablets, each tablet being located partly inside a respective depression, each tablet being formed in situ in the first packaging element, from at least a fluent, temperature-settable matrix, and having a lower portion within the respective depression of a predetermined convex shape, determined by the shape of the depression, a defined size and an upper portion, outside the respective depression, substantially of the same predetermined convex shape and defined size, and a second packaging element which overlies and which is secured to the first packaging element thereby to form, for each tablet, a respective enclosure.
